(19) United States
(12) Patent Application Publication
(10) Pub. No.: US 2013/0145247 A1
(43) Pub. Date: Jun. 6, 2013

(54) Synchronization Service Tree

(71) Applicant: James D. Reilly, Boston, MA (US)

(72) Inventor: James D. Reilly, Boston, MA (US)

(73) Assignee: Google Inc., Mountain View, CA (US)

(21) Appl. No.: 13/312,568

(22) Filed: Dec. 6, 2011

(51) Int. Cl. G06F 17/00

(52) U.S. Cl. 715/229

(57) ABSTRACT

Methods and systems for synchronizing magazine editions on mobile devices are described. Such embodiments provide for more efficient and reliable synchronization of magazine editions on mobile devices. Device information for a mobile device is obtained. Edition content to be provided to the mobile device is determined based on the device information. Multiple branches of a synchronization data relationship tree are generated, each branch representing a category of the edition content to be synchronized. Edition content nodes are dynamically generated to descend from each of the at least two branches. Each node represents a portion of the edition content of the category to be synchronized. Content associated with each edition content node is provided to the mobile device.

### TECHNICAL FIELD

The embodiments relate generally to synchronizing content within media applications on computing devices.

### BACKGROUND

Media content may be organized and displayed on mobile devices with media applications. However, content updates to the mobile devices take relatively too much time, involve redundancies, and inefficiently use network bandwidth and device resources. Media content and organizational information are often consolidated and transmitted in large chunks. The media is not displayed until the large data chunks are received and organized by the organizational information.

Such updates are also inefficient when different mobile device are involved. For example, media content from a national newspaper may include images for a story, When updating the story content to a mobile device, five different versions of the same image may be sent to each device. One version may be best displayed on certain mobile phones, other versions for certain smart phones, and another image for a tablet. Therefore, each mobile device is receiving content that is not specific to the device.

### BRIEF SUMMARY

Methods and systems for synchronizing magazine editions on mobile devices are described. Such embodiments provide for more efficient and reliable synchronization of magazine editions on mobile devices. According to an embodiment, device information for a mobile device is obtained. Edition content to be provided to the mobile device is determined based on the device information. Multiple branches of a synchronization data relationship tree are generated, each branch representing a category of the edition content to be synchronized. Edition content nodes are dynamically generated to descend from each of the at least two branches. Each node represents a portion of the edition content of the category to be synchronized. Each edition content node is provided to the mobile device.

According to another embodiment for synchronizing magazine edition content on a mobile device, device information for the mobile device is provided to an edition producer server. Edition content nodes that descend from each of at least two edition category branches of a magazine edition are received. Each node represents a portion of the edition content of an edition content category to be synchronized. Updated edition content is generated from the received edition content nodes and rendered on the mobile device.

Other embodiments of this aspect include corresponding systems, apparatus, and computer programs, configured to perform the actions of the methods, encoded on computer storage devices. Further embodiments, features, and advantages, as well as the structure and operation of the various embodiments are described in detail below with reference to accompanying drawings.

### BRIEF DESCRIPTION OF THE FIGURES

Embodiments are described with reference to the accompanying drawings. In the drawings, like reference numbers may indicate identical or functionally similar elements. The drawing in which an element first appears is generally indicated by the left-most digit in the corresponding reference number.

FIGS. 1A-1D illustrates a system for magazine editions, according to an embodiment.

FIG. 2 illustrates a system for magazine edition synchronization, according to an embodiment.

FIG. 3 is an example of display views of the system of FIG. I.

FIG. 4 illustrates a diagram of content synchronized by the system for magazine editions shown in FIG. 2.

FIG. 5 illustrates a method for magazine edition synchronization, according to an embodiment.

FIG. 6 illustrates a diagram of a synchronization service tree, according to an embodiment.

FIG. 7 illustrates another method for magazine edition synchronization, according to an embodiment.

FIG. 8 is a block diagram of a computer system with which various embodiments of the invention can be implemented.

### DETAILED DESCRIPTION

Embodiments are described herein with reference to illustrations for particular applications. It should be understood that the invention is not limited to the embodiments. Those skilled in the art with access to the teachings provided herein will recognize additional modifications, applications, and embodiments within the scope thereof and additional fields in which the embodiments would be of significant utility.

It would also be apparent to one of skill in the relevant art that the embodiments, as described herein, can be implemented in many different embodiments of software, hardware, firmware, and/or the entities illustrated in the figures. Any actual software code with the specialized control of hardware to implement embodiments is not limiting of the detailed description. Thus, the operational behavior of embodiments will be described with the understanding that modifications and variations of the embodiments are possible, given the level of detail presented herein.

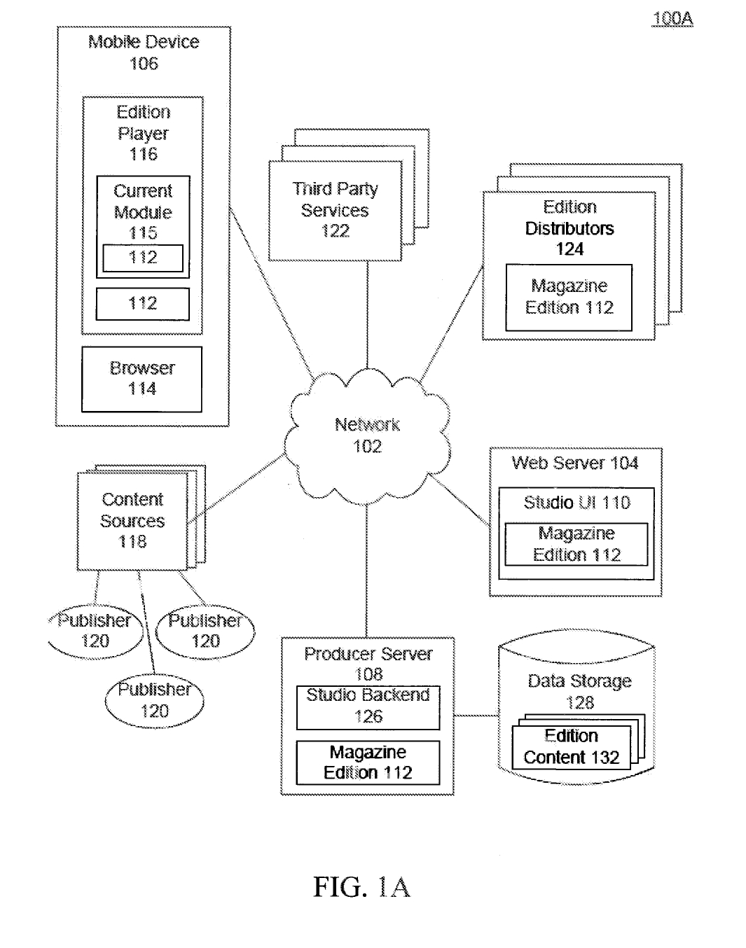

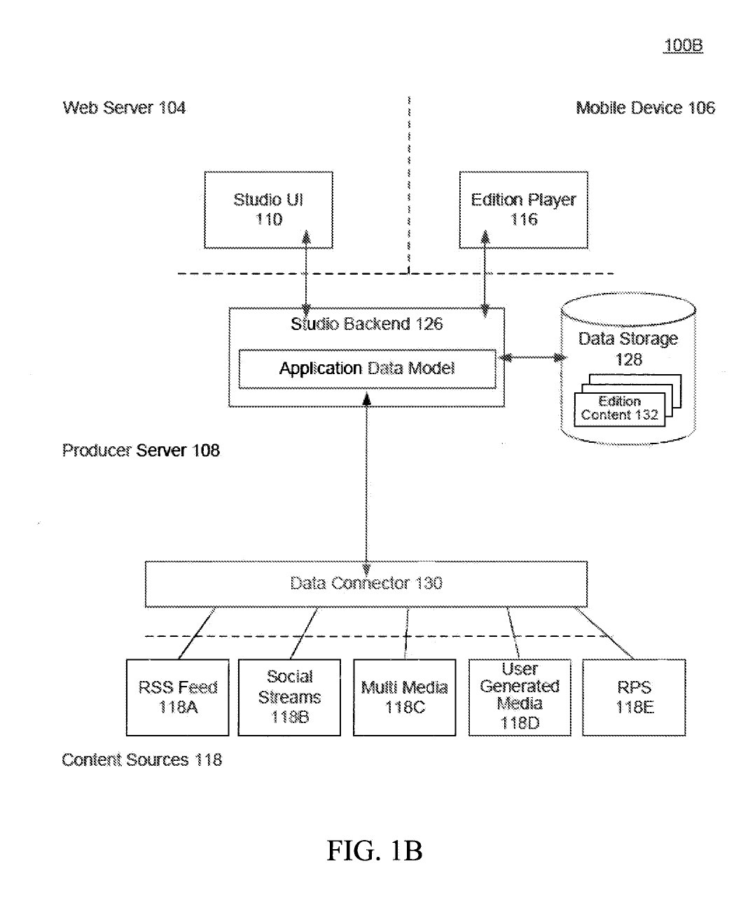

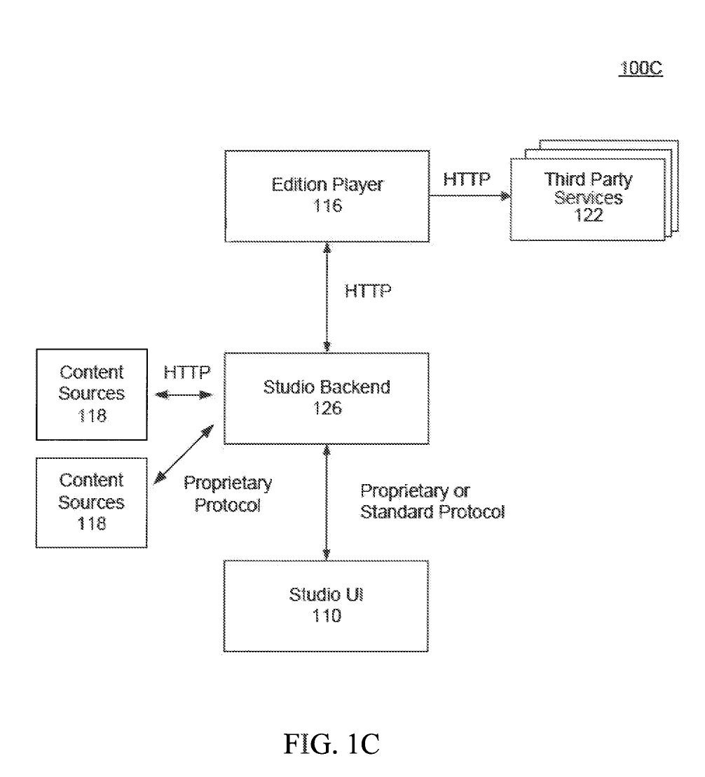

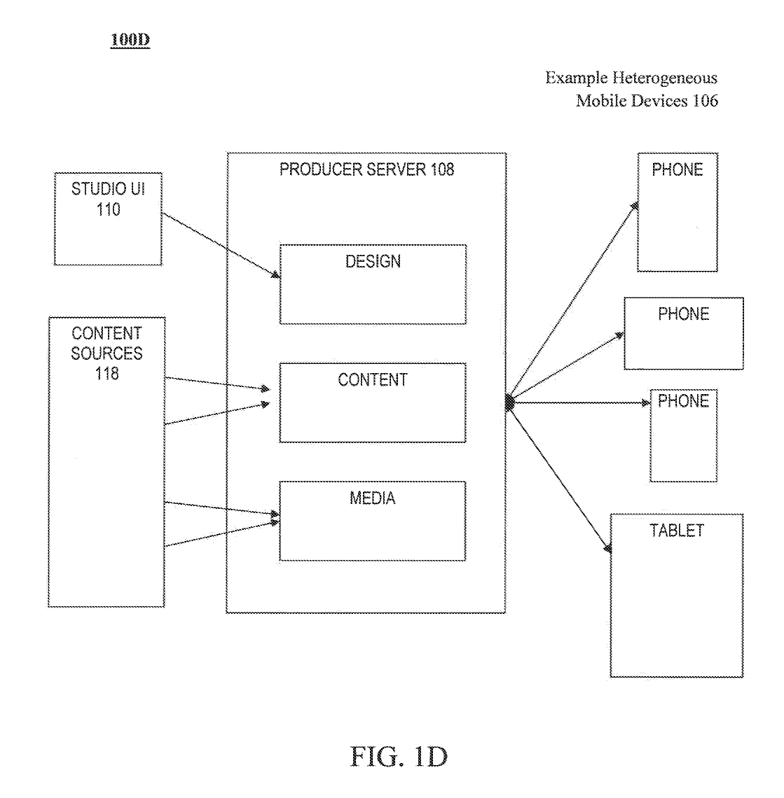

FIG. 1A is a block diagram 100A of a distributed system environment. Distributed system environment 100A includes one or more networks 102, web servers 104, producer servers 108 and mobile devices 106.

Network 102 may be any network or combination of networks that can carry data communications. Such a network 102 may include, but is not limited to, a local area network, metropolitan area network, and/or wide area network such as the Internet. Network 102 can support protocols and technology including, but not limited to, World Wide Web (or simply the “Web”), protocols such as a Hypertext Transfer Protocol (“HTTP”) protocols, and/or services, Intermediate web servers, gateways, or other servers may be provided between components of the system shown in FIG. 1, depending upon a particular application or environment.

Web server 104 is a computing device or an application executing on a computing device that hosts multiple websites. A website is one or more resources associated with a domain name and hosted by one or more web servers 104. An example website is a collection of webpages formatted in hypertext markup language (HTML) that can contain text, images, multimedia content, and programming elements, such as scripts. Web server 104 hosts studio user interface (“UI”) 110. Studio UI 110 enables users, such as publishers 120, to design interactive magazine editions 112 that may be distributed to multiple mobile devices 106.

Magazine editions display content in user designed layouts tailored to the displays of specific mobile devices. Instances of magazines are presented as editions. Editions include organized content sections that have multiple articles or posts related to the topic of the edition. Editions may be generated by subscription providers, such as magazine or newspaper organizations. Editions may also involve content generated by other content providers, including consumer, user generated or social media. A search magazine edition may search, gather and present information about a topic of the magazine edition from news and content providers, user generated sources and other informational sources.

Publisher 120 may access studio 110 using a web address that is hosted on web server 104. Once accessed, publisher 120 may use studio 110 to design the layout of magazine edition 112 for heterogeneous computing devices 106. In another embodiment, publisher 120 may download studio 110 onto a mobile device 106 as a standalone application, plugin or extension to browser 114.

Magazine edition 112 may be designed using studio UI 110. Magazine edition 112 displays edition content to users in, for example, a format specified by publishers 120. However, unlike conventional applications that include a separate version for each mobile device having a particular operating platform, edition content displayed using magazine editions 112 may be displayed on mobile devices 106 in a format that is specified by a particular publisher, regardless of the native operating platform particular to mobile device 106. Magazine editions 112 may also layout edition content according to the size of a display screen of mobile device 106.

Mobile device 106 is an electronic device that is under the control of a user and is capable of requesting and receiving resources over network 102. Example mobile devices 106 are mobile communication devices such as smart phones and tablet computers. Mobile device 106 typically includes an application, such as a web browser (or simply browser) 114. A user controls browser 114 to request resources over network 102. A user requests a resource by typing the website address associated with the resources that is stored on web server 104. For example, a user, such as publisher 120 may use browser 114 to access studio UI 110 to design an interactive magazine edition using mobile device 106.

Mobile device 106 also includes edition player 116. Edition player 116 displays magazine editions 112 to users. Magazine edition 112 displays dynamic media content on mobile devices 106, where mobile devices have different specifications and display screen size. Edition content included in magazine editions 112 includes content downloaded to magazine editions 112 using content sources 118. To display magazine editions 112, edition player 116 may use a current module 115 or display edition content using edition player 116.

Current module 115 stores magazine editions 112 which are published by publisher 120. Current module 115 may be downloaded to mobile device 106 from, for example, producer server 108 using network 102 or using another interface. Typically, once current module 115 is downloaded to mobile device 106, a user uses current module 115 to subscribe to magazine editions 112. Once subscribed, current module 115 uses mobile device 106 to download magazine editions 112 from producer server 108, or edition distributor 124. Current module 115 also updates magazine edition 112 with new edition content. In an embodiment, current module 115 also provides a user with a listing of recommended magazine editions 112 that may be of interest to the user and that a user may subscribe to.

Producer server 108 includes studio backend 126. Studio backend 126 allows for a design, development and implementation of magazine editions 112. Studio backend 126 communicates with studio UI 110 when publisher 120 uses studio UI 110 to design magazine edition 112.

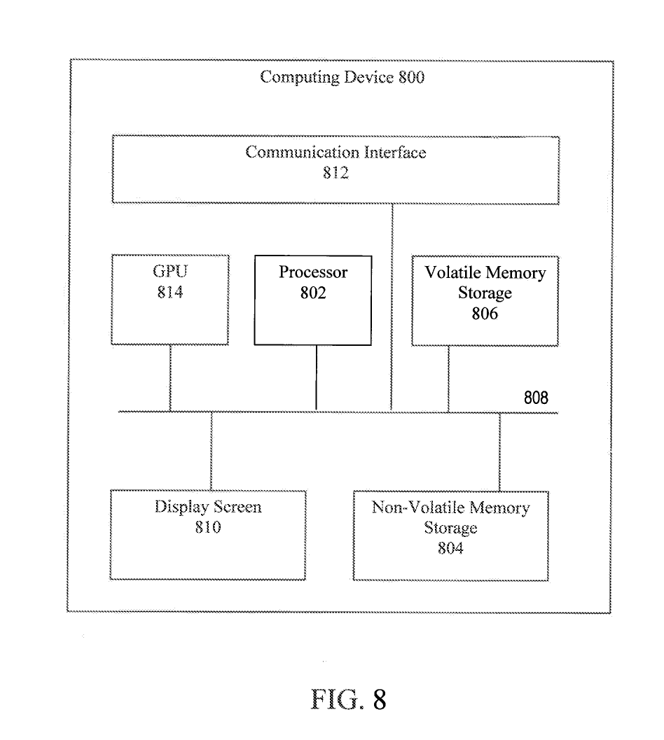

Once publisher 120 completes designing magazine edition 112 using studio UI 110, magazine edition 112 is uploaded to producer server 108 for storage and distribution. In an embodiment, magazine editions 112 may be stored on producer server 108 in a memory storage described in detail in FIG. 8. In another embodiment, publisher 120 may upload magazine edition 112 to edition distributors 124. A user may access edition distributor 124 and download magazine edition 112 to mobile device 106. In an embodiment, once publisher 120 decides to distribute an upgraded magazine edition 112, mobile devices 106 that include a previous version of magazine edition 112 are synchronized with the upgraded magazine edition 112.

Content sources 118 provide edition content 132 to magazine edition 112. Example content sources 118 include data feeds, RSS feeds, social streams, user-generated media sources, multi-media sources via media RSS, etc. Content source 118 is typically associated with a publisher 120. Publisher 120 owns a particular content source 118 and controls edition content 132 that is distributed via content sources 118 over network 102.

Producer server 108 receives edition content 132 from content sources 118. Once received, producer server 108 stores edition content 132 in data storage 128. Data storage 128 may be a memory storage described in detail in FIG. 8. In an embodiment, data storage 128 may include a database for storing edition content 132. When magazine edition 112 executing on edition player 116 requests edition content 132, producer server 108 retrieves edition content 132 is retrieved from data storage 128 and transmits edition content 132 to edition player 116.

Third party services 122 provide services to magazine editions 112. For example, third party services 122 provide streaming video that may be accessed by a uniform resource locator (“URL”) link included in magazine edition 112. In another example, third party services 122 determine that a user read a particular article included in magazine edition 112. In another example, third party services 122 provide advertisements for display within magazine edition 112. In another example, third party services 122 provide check out services for merchandise items that are provided for purchase within magazine edition 112.

Edition distributors 124 distribute applications, such as magazine editions 112 to mobile devices 106. For example, when publisher 120 designs magazine edition 112, publisher 120 may elect a particular edition distributor 124 to distribute magazine edition 112. When publisher 120 elects to distribute magazine edition 112 using a particular edition distributor 124, magazine edition 112 is uploaded to edition distributor 124. A user may then use mobile device 106 to access edition distributor 124 and upload magazine edition 112 onto mobile device 106 for an agreed upon fee.

FIG. 1B is a block diagram 100B of components in distributed system 100 that generate and distribute magazine editions.

As described herein content sources 118 provide edition content 132 that is distributed across the web via network 102. For the edition content 132 to be distributed using magazine editions 112, content sources 118 are connected to producer server 108. In an embodiment, data connector 130 connects multiple content sources 118 and retrieves edition content 132.

Data connector 130 receives data from content sources 118. Data connector 130 may receive edition content 132 from content sources 118 in real-time or at configurable intervals that may be set by a system administrator. Once data connector 130 receives edition content 132 from content sources 118, data connector 130 transmits edition content 132 to data storage 128.

As described herein, data storage 128 distributes data from content sources 118 to magazine editions 112. For example, mobile device 106 may request data for particular magazine editions 112 at configurable time intervals that may be configured by the user subscribing to magazine editions 112.

Studio backend 126 receives the designed magazine editions 112 from studio UI 110. As described herein, studio UI 110 allows publishers 120 to design dynamic and interactive magazine editions that display edition content 132 provided by their content sources 118. Once publisher 120 completes designing magazine edition 112, publisher 120 uploads magazine edition 112 to studio backend 126. Studio backend 126 then stores the uploaded magazine editions 112 on producer server 108 and/or distributes magazine editions 112 to mobile devices 106 or edition distributors 124.

Studio backend 126 includes application data model. Application data model (described in detail below), includes a format that displays edition content 132 within magazine editions 112. When publisher 120 uses studio UI 110 to create a particular magazine edition 112, studio UI 110 presents publisher 120 with application data model 134 framework that publisher 120 may configure to include edition content 120 for presentation to a user.

Upon a user request from mobile device 106, studio backend 126 may distribute magazine editions 112 to mobile devices 106. Each magazine edition 112 includes application data model 134 that is configured by publisher 120.

When magazine edition 112 is uploaded to mobile device 106, magazine edition 112 is populated with edition content 132. For example, producer server 108 provides edition content 132 from data storage 128 to magazine edition 112. As edition content 132 is updated with new edition content 132 from content sources 118, producer server 108 synchronizes edition content 132 included in magazine edition 112 with the new edition content 132 that is included in data storage 128.

In an embodiment, the synchronization may occur at configurable time intervals that may be configured by a user using mobile device 106. For example, a user may configure magazine edition 112 to query data storage 128 for new content every hour, every twelve hours, once a day, when requested by a user, etc. In a further embodiment, magazine edition 112 receives edition content 132 from data storage 128 that has been updated since the previous synchronization period, as to minimize the transmission of data over network 102.

FIG. 1C is a block diagram 100C that describes an exemplary communication interface between the components within the distributed system.

For example, edition player 116 may communicate with studio backend 126 using HTTP over network 102. Edition player 116 may also communicate to third party services 122 and edition distributors 124 using HTTP.

Studio UI 110 may communicate with studio backend 126 using a Google Web Toolkit (“GWT”) infrastructure. A person skilled in the art will appreciate that GWT allows web application developers to design JavaScript front-end applications using Java source code. In an embodiment GWT uses protocol buffers, also known to a person of ordinary skilled in that art, to pass data that includes magazine editions 112, templates, edition content 132, etc., between studio UI 110 and studio backend 126.

Studio backend 126 also communicates with a variety of content sources 118. In one embodiment, studio backend 126 may be configured to communicate with content sources 118 using a proprietary communication protocol that is specified by a particular content source 118. In another embodiment, studio backend 126 may also communicate with content sources 118 using HTTP.

FIG. 1D illustrates an example magazine edition system 100D, according to an embodiment. User studio UI 110 is used to design a magazine edition 112 that has a different layout for content received from content sources 118, or a layout that adjusts for mobile device having different specifications, such as mobile device types and sizes.

Magazine editions 112 can involve time-sensitive content that changes on a monthly, weekly, daily, hourly or real-time basis. It is important that mobile devices 106 display the most recent edition and remain functional.

Embodiments for synchronizing magazine edition content on mobile devices 106 are provided. Synchronization is performed incrementally so as to not consume more device bandwidth or resources than necessary. This allows for mobile device 106 to provide constant functionality and availability of magazine editions 112 while edition content 132 is synchronized with the content produced or distributed at the producer server 108. Synchronization is performed in more incremental steps and is tailored to the specific mobile device 106.

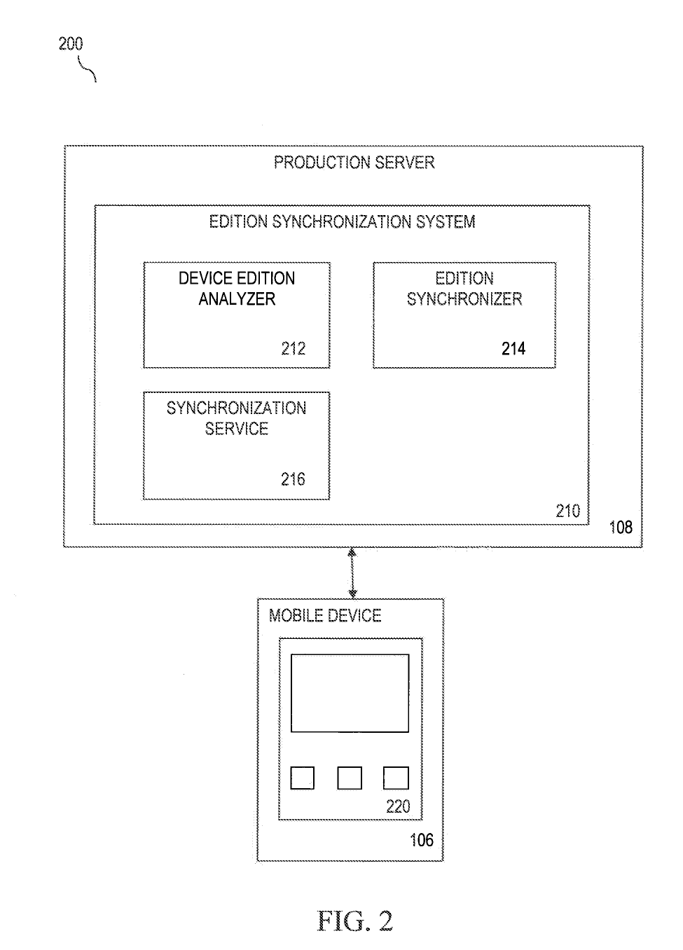

FIG. 2 illustrates an example system 200 for providing magazines, according to an embodiment. System 200 includes magazine edition synchronization system 210 and mobile display 220. System 200 may be implemented on or implemented with one or more computing devices, such as production server 108. System 200 may also be implemented by an edition distributor coupled to the producer server, directly or over a network 102. Edition synchronization system 210 may be software, firmware, or hardware or any combination thereof in a computing device. A computing device can be any type of computing device having one or more processors. For example, a computing device can be a computer, server, workstation, mobile device (e.g., a mobile phone, personal digital assistant, navigation device, tablet, laptop or any other user carried device), game console, set-top box, kiosk, embedded system or other device having at least one processor and memory. A computing device may include a communication port or I/O device for communicating over wired or wireless communication link(s).

Edition system 210 may be coupled to mobile device 106, according to an embodiment. Computing devices such as a monitor, all-in-one computer, smart phone, tablet computer, remote control, etc., may include a touch screen display 220 that accepts user input via touching operations performed by a user's fingers or other instrument. For example purposes, a touch sensor grid may overlay the display area. The touch sensor grid contains many touch sensitive areas or cells which may be used to locate the area closest to the input of a user's touch.

Example touch operations using touch screen display 220 may include (but are not limited to) pinching, finger (or other stylus or object) touches, finger releases, and finger slides. The touch screen display 220 may include a screen or monitor that may render text and/or images.

According to an embodiment, edition synchronization system 210 includes a device edition analyzer 212 and an edition synchronizer 214. System 210 may also include synchronization service 216 in further embodiments. Device edition analyzer 212 is configured to obtain display screen information for a mobile device. This information may include display screen dimensions such as the length and width of the screen, the ratio of the length to the width, or any other information related to the dimension of the screen.

In some cases, the portion of the screen allotted for the display of the magazine application may be a portion of the display screen while the remaining portions of the screen are reserved for menu bars or other tools. In such a case, screen dimension information will be directed to the dimensions of the screen reserved for the display of the magazine application.

Display screen information may also include a screen resolution, such as the number of pixels, or the number of pixels or lines in each dimension. There may be resolution standards, such as high definition standard resolutions. Three dimensional resolutions may also be part of the display screen information. Display screen information may also include color information or any other information that would be necessary to determine the display version for the edition content. Central processing unit (CPU), graphics processing unit (GPU), memory, network or wireless bandwidth capabilities, software and operating system information may also be part of the display screen information that is used for determining a most effective strategy for synchronization of magazine edition content to the specific mobile device. In other embodiments, a mobile device may have multiple display areas and display screen information may be provided for each of these display areas or display screens.

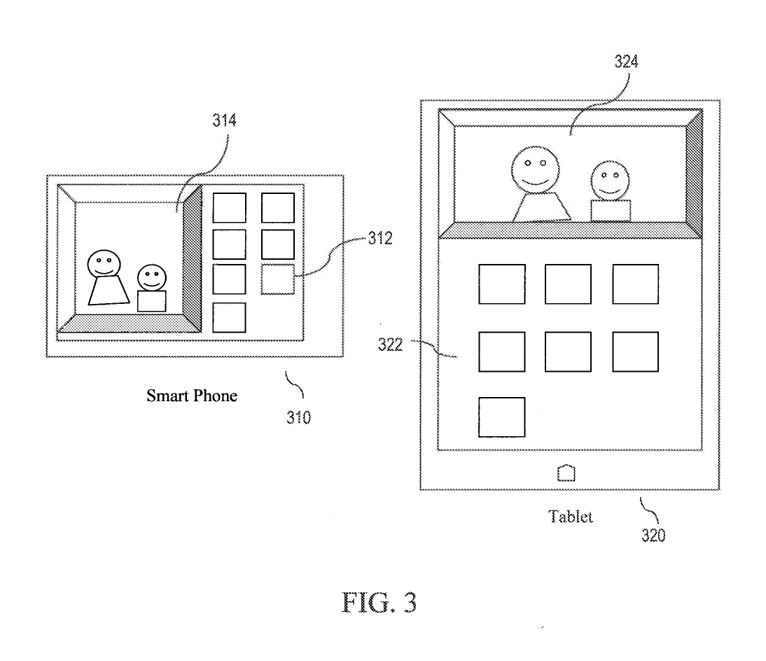

This information is important because the layout of the edition content display may vary based on the device. For example, FIG. 3 shows smart phone 310 and tablet 320, which are heterogeneous examples of mobile device 106. Smart phone 310 shows an example display 312 of seven editions and a prominent graphic of two faces at the top left. Display 312 may change as smart phone 310 is rotated to a portrait orientation.

Tablet device 320 of FIG. 3 shows the same edition content but in a larger display 322. The display screen of tablet 320 is larger with a more even length-to-width ratio. The prominent picture 314 of display 312 is a more complete, uncropped image 324 in display 322. Also, the seven edition icons of display 312 are larger and arranged differently. As shown by the embodiments in FIG. 3, the prominent and edition icon images of display 322 of the tablet are different versions of the images than those used in display 312 of the small, narrower smartphone. Edition content changes must account for the uniqueness of the mobile device for more efficient synchronization.

Edition synchronization system 210 is configured to determine edition content changes for magazine edition 112 presented on mobile device 106. Changes may be determined for each magazine edition 112 that is displayed on mobile device 106. Some magazine editions 112 may not be displayed on the device but may be stored for presentation at another time. Changes for this content may also be determined. Edition content changes may include providing magazines and edition content to a mobile device 106 for the first time when the edition had not existed on the mobile device.

Edition content changes include changes to subscriptions for a user and/or mobile device 106. Subscription changes since a last synchronization may be determined. Perhaps, a user recently canceled one subscription and added another to his or her account from another computing device. These changes would be synchronized with mobile device 106. Upon contact and a network handshake between producer server 202 and mobile device 220, subscription information, including magazine editions 112 most recently associated with the user, would be determined by device edition analyzer 212 and provided to mobile device 106 by edition synchronizer 214. In some cases, a user may configure mobile device 220 to receive different subscription or edition information than another mobile device.

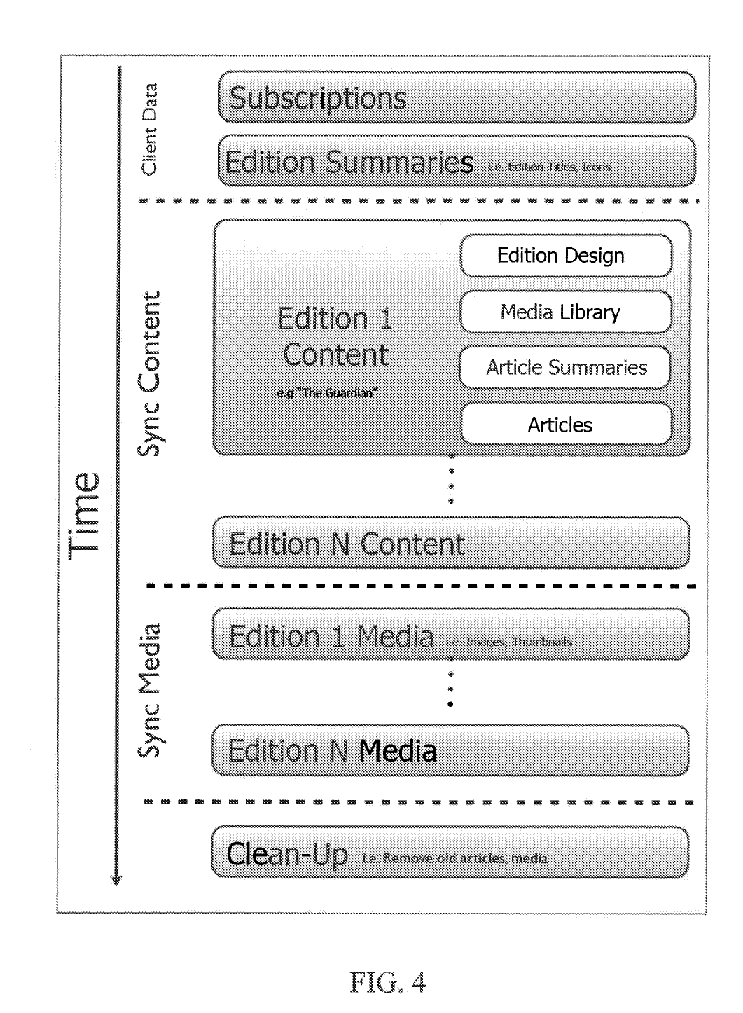

Other categories of content changes are shown in FIG. 4. Device edition analyzer 212 determined changes in content of these categories or types of information and any user information associated with the mobile device. Device edition analyzer 212 determines what information or content should be provided to mobile device 106 based on the specification of the mobile device and its display screen information. Timestamps associated with edition content may be used to determine what content to synchronize. In some cases, all content changes would be synchronized each time. In other cases, only certain content changes would be synchronized at certain times.

According to an embodiment, edition synchronizer 214 is configured to provide information for each category of FIG. 4 in separate synchronization segments. If one segment fails, that segment is restarted or continued. Modular synchronization provides for a reduced chance of interrupting the user experience.

Edition synchronizer 214 provides edition summaries. Edition summaries include edition titles and icons representing the edition. Changes to edition titles and summaries may vary in frequency. For example, monthly subscriptions may change monthly or daily. Trending editions, or editions based on the most recent news or hot topics, may change hourly or in real-time.

Edition synchronizer 214 may then provide edition content in separate stages, including edition design, media library, article summaries and articles or posts. Edition content may also include featured content.

Edition synchronizer 214 provides edition design information specific to the edition content changes to mobile device 106. Edition design information may include layout templates for integrating and displaying edition content in a certain manner or layout. This layout may be designed by a user or publisher 120 using an interface, such as studio UI 110. The edition design information is specific to the mobile device and its display screen information. It may also include a layout for each orientation of the mobile device.

Edition synchronizer 214 provides media library information specific to the edition content changes to mobile device 106. Media library information includes an icon or visual representation of the edition, edition resources and header images for each edition. Such information may also include splash screen images or prominent images. Library information may include style information such as cascading style sheets (CSS) and/or scripting languages, such as, JavaScript.

Edition synchronizer 214 provides article summaries specific to the edition content changes. Article summaries include a snippet of text of an article and a first best image. A first best image may include the first quality image or a prominent image. Other featured content specific to the edition content changes may be included, including a prominent display image or video to be prominently featured when displayed. Audio content may also be featured.

Edition synchronizer 214 provides article content specific to the edition content changes to mobile device 106. Article content may include news articles, information articles, investigative story articles, entertainment articles and any other media article. Article content may also include posts, such as blog or social media posts, including tweets. In an example, if an article has several different resolution versions of images for an article, device edition analyzer 212 selects the best image based on the mobile device display screen size, ratio and resolution (possibly for each device orientation) rather than transmitting multiple versions of an image only because the synchronization had not been device specific. In the case of trending search magazines, not all edition content or edition media would be synchronized on mobile device 106 for each edition. Rather, summaries may be provided.

Edition synchronizer 214 provides new edition media or edition media. The media may be specific to the edition content changes. Edition media may include images, thumbnails, video, info graphics, audio, streaming content, user-generated media or any other media content. Search magazine editions may utilize the most recent news, the most recent user-generated content and the most recent informative or descriptive content. Search magazines may automatically search for content of each listed category and display the content using designed edition layout information.

Edition synchronizer 214 is configured to provide each of these portions of edition content or edition media in separate synchronization steps. In a further embodiment, edition synchronizer 214 is configured to provide each portion of edition content independent of other segments or categories of information. If any of these synchronization steps fails to start or complete, edition synchronizer 214 restarts or continues synchronization at the failed providing step or the failed portion of the step. Focused, incremental synchronization does not consume a large amount of the network or processing resources.

According to a further embodiment, each portion of the incremental synchronization of the edition is rendered and available for use on the mobile device. Because integration of edition design, edition content and media content for presentation takes place at the mobile device, other portions of the edition content or edition media may be rendered while another portion is updated. In some cases, the portion being updated may be displayed until a portion of the update or all of the update is available to be rendered. Edition content changes may also be rendered or displayed immediately.

Edition synchronizer 214 may also provide deletion stubs of deleted content to indicate to the user of the mobile device that an edition is no longer available. Clean up may also be performed on older, outdated or unnecessary content or information. Older articles and media may be removed.

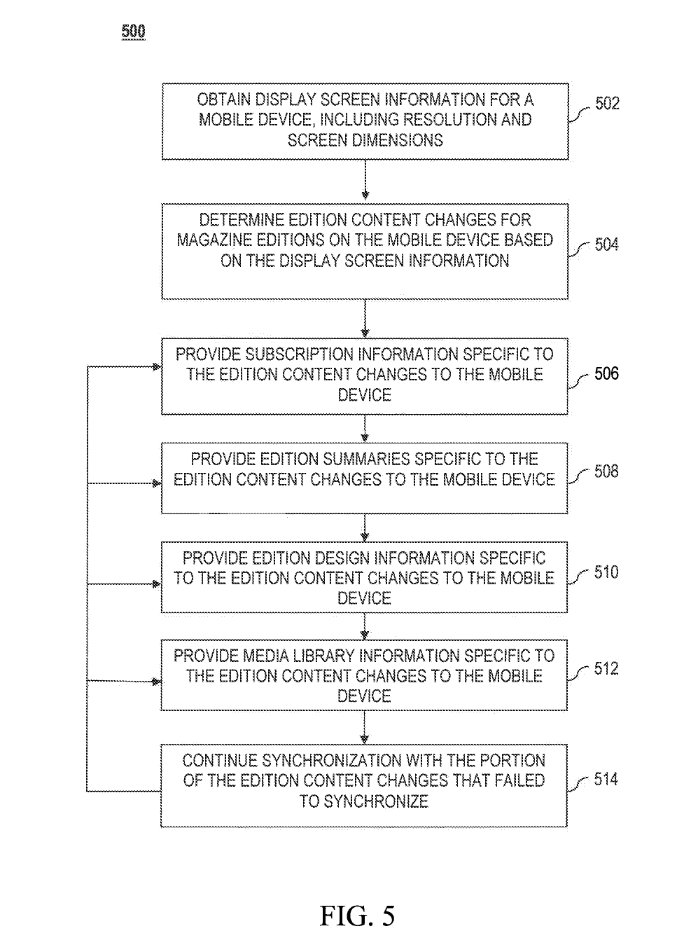

FIG. 5 is a flowchart illustrating an example method 500 for web page restoration, according to an embodiment. At stage 502, display screen information is obtained for a mobile device. This includes screen dimensions and resolution or any other information useful to determine what edition content is best suited for the device to efficient synchronization.

At stage 504, edition content changes are determined based on the display screen information. Only the changes in edition content and edition media specific will be synchronized with the mobile device. New content will also be synchronized. In an embodiment stages 502-504 are performed by device edition analyzer 212.

At stage 506, subscription information specific to the edition content changes are provided to the mobile device. At stage 508, edition summaries specific to the edition content changes are provided to the mobile device. At stage 510, edition design information specific to the edition content changes are provided to the mobile device. For example, if a publisher alters the two of four section sizes of a layout template of a magazine edition, those two new section sizes of the layout that have changed will be updated through synchronization.

At stage 512, media library information specific to the edition content changes are provided to the mobile device. Media library information includes information about how to present a magazine edition or a group of magazine editions, including what icons or content samples to provide. In some cases, an image or icon may be selected over another image based on the display screen information. Each of stages 506-512, may be performed independently of each other. In some embodiments, providing independently may include providing the category of content in a modular portion of data. This may include data associated within a single network access or transmission.

At stage 514, if any of stages 506-512 fail to synchronize the mobile device, synchronization of that stage is restarted or continued. Modular synchronization of only edition content changes provides for more fault free synchronization and usability of magazine editions during synchronization. Edition content changes may also be specific to the mobile device. For example, if a high quality image has been updated by a publisher, but the existing image on the device is more suitable based on the screen size or current use of the magazine edition, the updated image may not be synchronized with the mobile device at the next synchronization so as to preserve the user experience of enjoying the magazine edition on the mobile device. In an embodiment stages 506-514 are performed by edition synchronizer 214.

According to another embodiment, synchronization service 216 may be configured to organize edition content changes in order to perform synchronization in smaller modular increments. In some cases, smaller portions may involve only one network call and/or one database call.

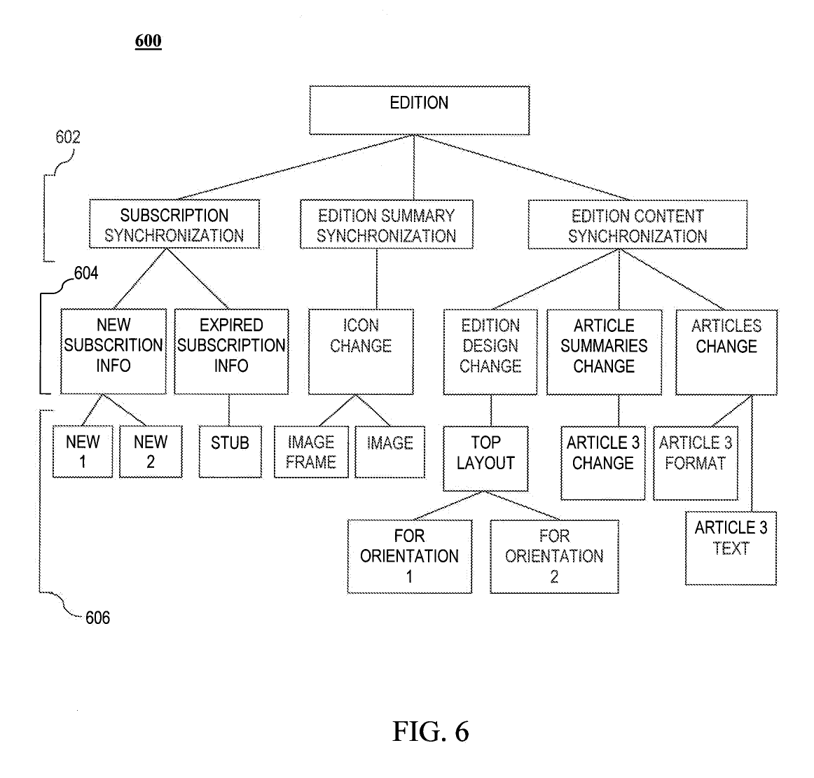

Synchronization service 216 may organize edition content changes into a data structure. For example, FIG. 6 shows an example synchronization service tree 600 used for synchronizing magazine edition content. From the edition root, at least three branches 602 are shown, including subscription synchronization, edition summary synchronization and edition content synchronization. Other branches related synchronization categories of the edition may be added. After these branches are generated, another level of branches 604 may be generated, each branch related to the parent branch. Other levels of branches may be generated to provide more granularity of edition content to be synchronized.

In some cases, a publisher or user may prioritize the synchronization of editions among other editions. In other cases, trees or portions of a tree or a category may be prioritized or reorganized. These reorganizations or prioritizations may be based on the context of the synchronization, including edition content, user characteristics or preferences, device specifications or other content related or resource related factors.

According to a further embodiment, synchronization service 216 may generate nodes 606 that descend from these branches, the nodes representing portions of edition content to be synchronized. Each node represents a stage of synchronization. If a node fails to synchronize, it could be restarted or continued. Some nodes could be synchronized in parallel. In some cases, nodes may be synchronized in a particular order. In other cases, nodes may be dynamically selected for synchronization based on a number of factors, including mobile device information, subscription information and edition information.

Synchronization of nodes of the synchronization service tree allows for more fault tolerant synchronization that does not interrupt the user's experience. According to an embodiment, synchronization service 216 may be executed by a single, possibly low priority, thread in order to not visibly affect the presentation of the editions.

Smaller nodes also provide for less retransmission or loss of data when a synchronization portion fails or is noticeably consuming network and processor resources. Node progress also provides for more accurate status bars. Because edition design and content integration occurs at the mobile device, other portions of the edition content or edition media may be rendered while another portion is updated. In some cases, the portion being updated is displayed until a portion of the update or all of the update is available to be rendered.

In an example using tree 600 of FIG. 6, it is determined that there have been some changes in a magazine edition. Tree 600 represents a subset of edition content changes to be synchronized. Two new subscriptions were recently added by the user of the mobile device from another computing device since the last synchronization. An edition icon has changed its image. The publisher has reconfigured how a top portion of the design layout of an edition is displayed. This design changes is propagated for both the portrait and landscape orientations of mobile devices. A third article was updated by a content provider. The article summary changed, and the format and text of the third article also changed.

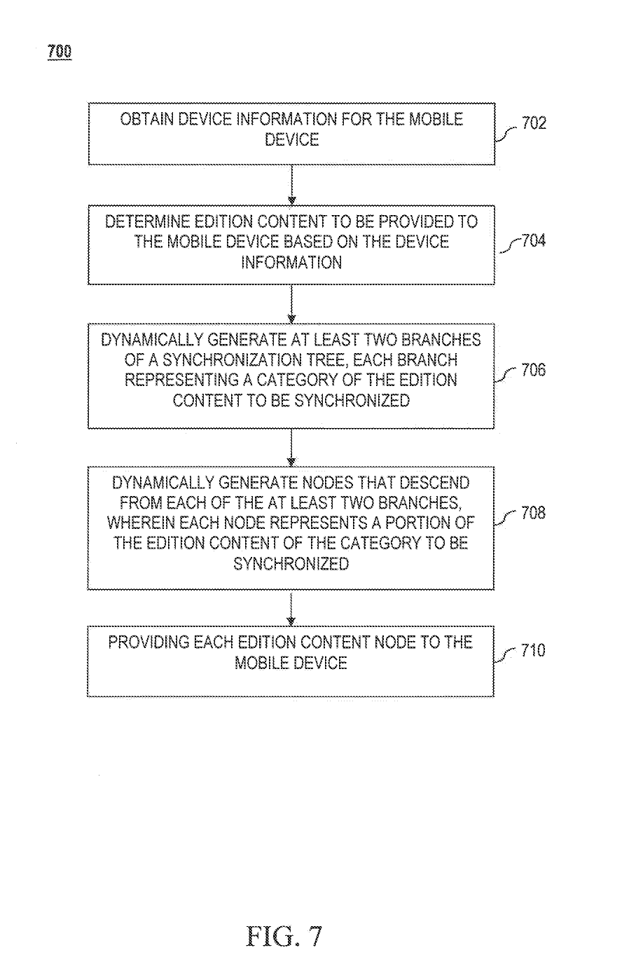

Tree 600 has been generated with branches and nodes in order to provide for more modular, user-friendly and fault tolerant synchronization of edition content as synchronization is to take place while the user is viewing this edition. FIG. 7 represents a flowchart illustrating an example method 700 for synchronization using tree 600, according to an embodiment.

At stage 702, device information is obtained for the mobile device. Device information may include display screen information, operating system and application information and other technical specification information of the mobile device.

At stage 704, it is determined what edition content is to be synchronized with the mobile device. As described above, this may include only changes to the content. This may also include new content. The content to be provided may be determined based on the device information. For example, a smart phone or tablet on a higher speed network may receive denser images than a smart phone with slower network service. In an embodiment, stages 702-704 may be performed with a component similar to device edition analyzer 212.

At stage 706, branches of a synchronization tree are generated. Each branch is represents a category of edition content to be synchronized. Such categories are explained above and also shown in FIG. 4. In the example of FIG. 6, subscription, edition summary and edition content branches are generated. FIG. 4 is not meant to be an exhaustive list of edition content categories.

Branch generation may include defining relationships or creating pointers to different elements of data. Branch generation may also include searching, copying, modifying, packaging, combining or parsing existing content edition data. Branch generation is dynamic in that it is performed at the time synchronization is indicated or initiated. In some cases, branch generation may be performed dynamically when a publisher updates edition content. It is also possible for branch generation to be performed at a time between publisher modification and mobile device synchronization. Perhaps, at a time when resources are less utilized at producer server 108 or web server 104.

Other branches may be generated either from the root edition or the previously generated branches. In the example of FIG. 6, the next level of branches includes new and expired subscription information, an icon change, an edition design change, an article summaries change and a change to an article. A further level of branches may include the top of an edition design layout template.

At stage 708, edition content nodes are generated. At this final level of the tree, tree nodes or leaves include quantized portions of edition content that will be provided to the mobile device. In some cases, such nodes may require only one network call and/or one database call. According to a further embodiment, one or more nodes may be packaged into a single packet or a distinct group of packets. Continuing with example tree 600, nodes may include two new subscription information nodes, a deletion stub node for a cancelled subscription, an image frame for an icon, the icon image itself, and layout templates for the top portion of an edition display (one node for each orientation). Edition content nodes may also include an addition to an article summaries portion, a format of a new article and the text of the new, third article. In an embodiment, stages 706-708 are performed with synchronization service 216.

At stage 710, each node is transmitted. The nodes may be transmitted separately. In some cases, multiple nodes may be provided in parallel or together. Edition content nodes may also be provided in separate synchronization transactions. Each synchronization transaction may be part of the same network session. They may also be separate network sessions. The modular nature of the nodes allows for more flexibility and dynamic decision making based on real-time information about the mobile device, edition content and other resources. Stage 710 may be performed by a component similar to edition synchronizer 214.

According to a further embodiment, a synchronization module on the mobile device or edition player 116 may be configured to receive the synchronized edition content. For example, device information for the mobile device is provided to edition producer server 108. Edition content nodes that descend from each of at least two edition category branches of a magazine edition are received in return. Each node represents a portion of the edition content of an edition content category to be synchronized. Updated edition content is generated from content associated with the received edition content nodes and rendered on the mobile device.

FIG. 8 is an example computer system 800 in which embodiments of the present invention, or portions thereof, may be implemented as computer-readable code. For example, the components or modules of edition synchronization system 210, such as edition analyzer 212, edition synchronizer 214 and synchronization service216, etc., may be implemented in one or more computer systems 800 using hardware, software, firmware, tangible computer-readable media having instructions stored thereon, or a combination thereof and may be implemented in one or more computer systems or other processing systems. Modules and components in FIGS. 1-7 may be embodied in hardware, software, or any combination thereof.

Computing devices, such as mobile devices 106, 310, 320 or producer server 108, may include one or more processors 802, one or more non-volatile storage mediums 804, one or more memory devices 806, a communication infrastructure 808, a display screen 810 and a communication interface 812.

Processors 802 may include any conventional or special purpose processor, including, but not limited to, digital signal processor (DSP), field programmable gate array (FPGA), application specific integrated circuit (ASIC), and multi-core processors.

GPU814is a specialized processor that executes instructions and programs,. selected for complex graphics and mathematical operations, in parallel.

Non-volatile storage 804 may include one or more of a hard disk drive, flash memory, and like devices that may store computer program instructions and data on computer-readable media. One or more of non-volatile storage device 704 may be a removable storage device.

Memory devices 806 may include one or more volatile memory devices such as but not limited to, random access memory. Communication infrastructure 808 may include one or more device interconnection buses such as Ethernet, Peripheral Component Interconnect (PCI), and the like.

Typically, computer instructions are executed using one or more processors 802 and can be stored in non-volatile storage medium 804 or memory devices 806.

Display screen 810 allows results of the computer operations to be displayed to a user or an application developer.

Communication interface 812 allows software and data to be transferred between computer system 800 and external devices. Communication interface 812 may include a modem, a network interface (such as an Ethernet card), a communications port, a PCMCIA slot and card, or the like. Software and data transferred via communication interface 812 may be in the form of signals, which may be electronic, electromagnetic, optical, or other signals capable of being received by communication interface 812. These signals may be provided to communication interface 812 via a communications path. The communications path carries signals and may be implemented using wire or cable, fiber optics, a phone line, a cellular phone link, an RF link or other communications channels.

Embodiments also may be directed to computer program products comprising software stored on any computer-useable medium. Such software, when executed in one or more data processing device, causes a data processing device(s) to operate as described herein. Embodiments of the invention employ any computer-useable or readable medium. Examples of computer-useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.).

The Summary and Abstract sections may set forth one or more but not all exemplary embodiments of the present invention as contemplated by the inventor(s), and thus, are not intended to limit the present invention and the appended claims in any way. Embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A method for synchronizing magazine edition content on a mobile device, comprising:
obtaining device information for the mobile device;
determining edition content to be provided to the mobile device based on the device information;
dynamically generating at least two branches of a synchronization tree, each branch representing a category of the edition content to be synchronized;
dynamically generating edition content nodes that descend from each of the at least two branches, wherein each edition content node represents a portion of the edition content of the category to be synchronized; and
providing content associated with each edition content node to the mobile device.

2. The method of claim 1, wherein each edition content node is provided in a separate transmission.

3. The method of claim 1, wherein generating at least two branches includes generating an edition summary branch and an edition synchronization branch.

4. The method of claim 1, further comprising prioritizing edition content nodes to synchronize with the mobile device.

5. The method of claim 1, wherein at least one of the edition content nodes involves a single network call and a single database call.

6. The method of claim 1, further comprising generating next level branches from the at least two branches.

7. The method of claim 1, further comprising resending content associated with edition content nodes that failed synchronization.

8. The method of claim 1, wherein the providing step is executed by a single low priority thread.

9. A system for synchronizing magazine edition content toon a mobile device, comprising:
a device content analyzer configured to:
obtain device information for the mobile device;
determine edition content to be provided to the mobile device based on the device information;
a synchronization service configured to:
dynamically generate at least two branches of a synchronization tree, each branch representing a category of the edition content to be synchronized;
dynamically generate edition content nodes that descend from each of the at least two branches, wherein each edition content node represents a portion of the edition content of the category to be synchronized; and
a content synchronizer configured to provide content associated each edition content node to the mobile device.

10. The system of claim 9, wherein the content synchronizer is further configured to provide each edition content node in a separate transmission.

11. The system of claim 9, wherein the synchronization service is further configured to generate an edition summary branch and an edition synchronization branch.

12. The system of claim 9, wherein the synchronization service is further configured to prioritize edition content nodes to synchronize with the mobile device.

13. The system of claim 9, wherein at least one of the edition content nodes involves only one network call and one database call.

14. The system of claim 9, wherein the synchronization service is further configured to generate next level branches from the at least two branches.

15. The system of claim 9, wherein the content synchronizer is further configured to provide resend edition content nodes that failed synchronization.

16. A method for synchronizing magazine edition content on a mobile device, comprising:
providing device information for the mobile device;
receiving edition content nodes that descend from each of at least two edition category branches of a magazine edition, wherein each node represents a portion of the edition content of an edition content category to be synchronized;
generating updated edition content from content associated with the received edition content nodes; and
rendering the updated edition content on the mobile device.

17. The method of claim 16, wherein rendering includes rendering the updated edition content while the magazine edition is available for use.

18. A computer readable storage medium having control logic stored therein that, when executed by a processor, causes the processor to synchronizing magazine edition content on a mobile device, the control logic comprising:
a first computer readable program code to cause the processor to:
obtain device information for the mobile device; and
determine edition content to be provided to the mobile device based on the device information;
a second computer readable program code to cause the processor to:
dynamically generate at least two branches of a synchronization tree, each branch representing a category of the edition content to be synchronized; and
dynamically generate edition content nodes that descend from each of the at least two branches, wherein each edition content node represents a portion of the edition content of the category to be synchronized; and
a third computer readable program code to cause the processor to provide content associated with each edition content node to the mobile device.
